(19) United States
(12) Patent Application Publication
(10) Pub. No.: US 2004/0260696 A1
(43) Pub. Date: Dec. 23, 2004

(54) Job management method, information processing device, program, and recording medium

(75) Inventors: Takeshi Matsuoka, Kawasaki (JP); Fumihiko Iwabuchi, Yokohama (JP); Shinichi Akiba, Yokohama (JP); Etsuji Oku, Yokohama (JP); Tsuyoshi Soejima, Yokohama (JP); Seiichi Tomita, Yokohama (JP); Masakazu Sato, Ebina (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/742,139

(22) Filed: Dec. 19, 2003

(30) Foreign Application Priority Data
Jun. 19, 2003 (JP) 2003-175273

(51) Int. Cl. G06F 17/60

(52) U.S. Cl. 707/5

(57) ABSTRACT

An object of the present invention is to provide a job management method for making it possible to reuse jobs in an ETL process. In the job management method, a job information table is accessed, jobs having table attributes and data field attributes matching between the respective jobs are retrieved, and, for each retrieved job, matching degrees of the data field attribute of “other jobs” in which the matching has been confirmed are calculated. Then, the “other jobs” in which the calculated matching degrees is equal to or more than a predetermined level are identified, and the identified “other jobs” are outputted to an output interface.

### CROSS-REFERENCE TO RELATED APPLICATIONS

The present application claims priority upon Japanese Patent Application No. 2003-175273 filed on Jun. 19, 2003, which is herein incorporated by reference.

### BACKGROUND OF THE INVENTION

1. Field of the Invention

The present invention relates to a job management method, an information processing device, program, and a recording medium.

2. Description of the Related Art

One system for retrieving and accumulating necessary data from a transaction system to obtain useful information for business management and the like is a data warehouse. Such a process of extracting data from a transaction system, integrating the extracted data to perform necessary code transformation, and loading the transformed data into a data warehouse is called an ETL process. Improvement in the productivity of this ETL process is an important theme in the construction of information systems containing data warehouses.

For example, there is the technology disclosed in Japanese Patent Application Laid-open Publication No. 2002-366401 as a technology for providing the construction of an integrated data mart and an operational system which solve the following problems: a large number of programs automatically generated are executed to lower the response; a system is only opened to limited persons such as staff; and, since tools are different from each other, if the tools are integrally used, the development costs are high, and therefore the number of users cannot be increased. Specifically, the technology provides a database construction-and-operation support system for making it possible to construct and operate a specific database in which data is extracted from a transaction database and processed and in which necessary information is saved. The database construction-and-operation support system comprises a unit for automatically generating the specific database. The unit for automatically generating the specific database includes a program structure storage function section for storing program structures previously prepared in order to generate a specific program specified by a user for processing the data from the transaction database, a program structure display function section for displaying the program structure selected from the program structure storage function section by the user, in a form in which a program is structured for each function, for the user, and a specific program generation function section for generating the specific program in response to a process content designation by the user for the program structure displayed by the program structure display function section.

However, no method has been proposed for effectively reusing jobs of an ETL process once architectured.

### SUMMARY OF THE INVENTION

The present invention has been made based on the above-described background, and provides a job management method, an information processing device, and a recording medium for making it possible to reuse jobs in an ETL process.

In order to achieve the above-described object, a job management method of the present invention is a method for managing jobs of an ETL process using an information processing device. The information processing device can access a job information table in which a table attribute and a data field attribute are related with each of a data extraction source and a data storing destination in each job of the ETL process. The method includes the steps of: accessing the job information table and retrieving the jobs which have the table attributes and the data field attributes matching between the respective jobs; calculating, for each retrieved job, a matching degree of the other jobs in which the matching has been confirmed; identifying the other job in which the calculated matching degree is equal to or more than a predetermined level; and outputting the identified other job to an output interface.

Moreover, the present invention relates to a method for managing jobs of an ETL process using an information processing device. The information processing device can access a matching information table in which the jobs having table attributes and data field attributes matching between the respective jobs of the ETL process for each of a data extraction source and a data storing destination are listed, and in which each job is related with a matching degree of the data field attribute with an other job. The method includes the steps of: accessing the matching information table, recognizing the matching degree with the other job for each job, and identifying the other job having the highest matching degree for each job; calculating frequencies in which the identified other jobs have been identified to have the highest matching degrees for the respective jobs; and listing the other jobs in order of the calculated frequencies and outputting the other jobs to an output interface.

Further, the present invention relates to an information processing device for managing jobs of an ETL process. The information processing device includes: a job information table in which a table attribute and a data field attribute are related with each of a data extraction source and a data storing destination in each job of the ETL process; a unit for accessing the job information table and retrieving the jobs which have the table attributes and the data field attributes matching between the respective jobs; a unit for calculating, for each retrieved job, a matching degree of the data field attribute of other job in which the matching has been confirmed; a unit for identifying the other job in which the calculated matching degree is equal to or more than a predetermined level; and a unit for outputting the identified other job to an output interface.

Furthermore, the present invention relates to an information processing device for managing jobs of an ETL process. The information processing device includes: a matching information table in which the jobs having table attributes and data field attributes matching between the respective jobs of the ETL process for each of a data extraction source and a data storing destination are listed, and in which each job is related with a matching degree of the data field attribute with an other job; a unit for accessing the matching information table, recognizing the matching degree with the other job for each job, and identifying the other job having the highest matching degree for each job; a unit for calculating frequencies in which the identified other jobs have been identified to have the highest matching degrees for the respective jobs; and a unit for listing the other jobs in order of the frequencies, and outputting the other jobs to an output interface.

Moreover, the present invention relates to a job management program for causing an information processing device capable of accessing a job information table in which a table attribute and a data field attribute are related with each of a data extraction source and a data storing destination in each job of the ETL process, to execute a method for managing jobs of an ETL process. The job management program includes the steps of: accessing the job information table and retrieving the jobs which have the table attributes and the data field attributes matching between the respective jobs; calculating, for each retrieved job, a matching degree of the data field attribute of other job in which the matching has been confirmed; identifying the other job in which the calculated matching degree is equal to or more than a predetermined level; and outputting the identified other job to an output interface. This program includes codes for performing operations of the respective steps.

Further, the present invention relates to a computer-readable recording medium having the job management program recorded thereon.

Furthermore, the present invention relates to a job management program for causing an information processing device capable of accessing a matching information table in which the jobs having table attributes and data field attributes matching between the respective jobs of the ETL process for each of a data extraction source and a data storing destination are listed and in which each job is related with a matching degree of the data field attribute with an other job, to execute a method for managing jobs of an ETL process. The job management program includes the steps of: accessing the matching information table, recognizing the matching degrees of the other jobs for each job, and identifying the other job having the highest matching degree for each job; calculating frequencies in which the identified other jobs are identified to have the highest matching degrees for the respective jobs; and listing the identified other jobs in order of the frequencies and outputting the identified other jobs to an output interface. This program includes codes for performing operations of the respective steps.

Further, the present invention relates to a computer-readable recording medium having the job management program recorded thereon.

Features and objects of the present invention other than the above will become clear by reading the description of the present specification with reference to the accompanying drawings.

### BRIEF DESCRIPTION OF THE DRAWINGS

For a more complete understanding of the present invention and the advantages thereof, reference is now made to the following description taken in conjunction with the accompanying drawings wherein:

FIG. 1 is a network configuration diagram containing a job management system (information processing device) in an embodiment of the present invention.

FIG. 2 is a view showing Table Group 1 in the embodiment.

FIG. 3 is a view showing Table Group 2 in the embodiment.

FIG. 4 is a main flow diagram of a job management method in the embodiment.

FIG. 5 is a diagram showing a procedure for storing job information.

FIG. 6 is a diagram showing a procedure for comparing job information.

FIG. 7 is a diagram showing a procedure for outputting similar jobs.

FIG. 8 is a view showing an output form example of the similar jobs.

FIG. 9 is a diagram showing a procedure for ordering job development.

FIG. 10 is a view showing the concept of a process of ordering the job development.

FIG. 11 is a diagram showing a procedure for outputting job development order.

FIG. 12 is a view showing an output form example of the job development order.

### DETAILED DESCRIPTION OF THE INVENTION

At least the following matters will be made clear by the explanation in the present specification and the description of the accompanying drawings.

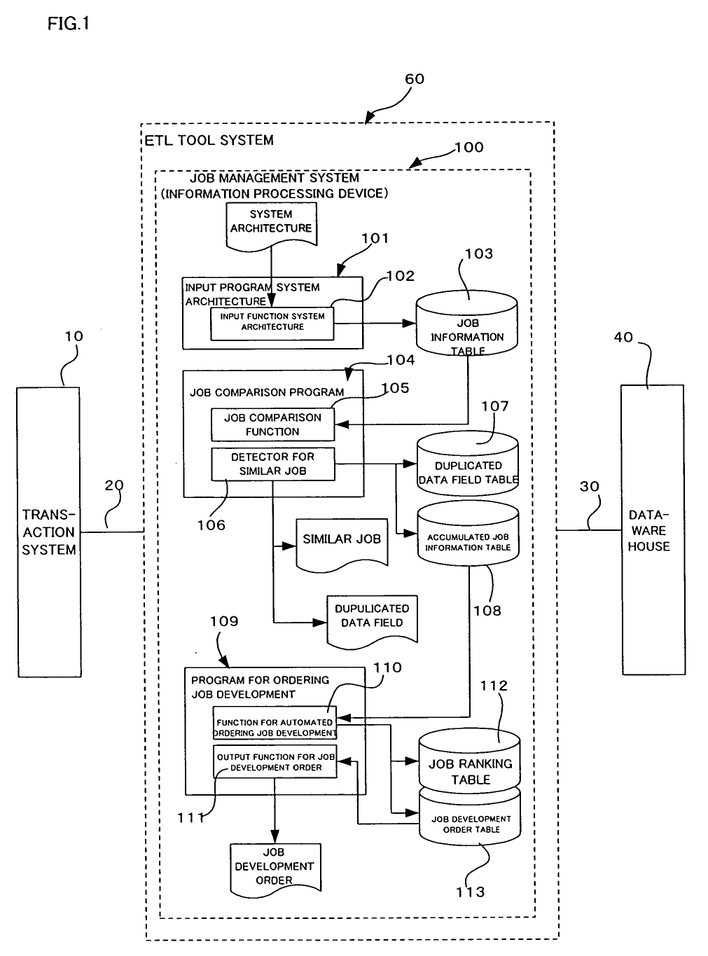

Hereinafter, an embodiment of the present invention will be described in detail using the drawings. FIG. 1 is a network configuration diagram containing a job management system (information processing device) in the present embodiment. For example, the job management system 100 (hereinafter called system) as the information processing device in the present invention can be considered to be incorporated into an ETL tool system 50 and function. Alternatively, the job management system 100 may be coupled to the ETL tool system 50 via an appropriate network, such as a LAN, to operate integrally with the ETL tool system 50.

Note that the ETL tool system 50 is a system which performs a process of extracting data from a transaction system 10 via a network 20, integrating the extracted data to perform necessary code transformation, and loading the transformed data into a data warehouse 40 via a network 30.

The system 100 performs job management accompanying the ETL process, for example, integrally with the ETL tool system 50. Accordingly, the system 100 holds programs realizing a job management method of the present invention in a storage device, such as a hard disk drive or a non-volatile memory. A processor of the system 100 reads out the programs from the storage device and executes the programs in accordance with operating systems (OS), whereby the job management method is realized. Of course, as an information processing device, the system 100 has an adapter for transmitting/receiving data to/from the ETL tool system 50, an output interface for outputting various kinds of data, and an input interface for accepting selection or directions from an operator of the system.

Such a system 100 is configured of some programs and table groups. The programs include a system architecture input program 101 (which has a function block referred to as a system architecture input function 102) for accepting the entry of jobs of an architectured ETL process, a job comparison program 104 (which has a function block referred to as a job comparison function 105 and a function block referred to as a similar job detector 106) for comparing the jobs and identifying similar ones, and a job development ordering program 109 (which has a function block referred to as a function 110 for automated ordering job development and a function block referred to as a output function 111 for job development order) for selecting a job which makes job development efficient, as a job to be reused, among the similar jobs.

Meanwhile, the table groups include a job information table 103, a duplicated data field table 107, an accumulated job information table 108 (matching information table), a job ranking table 112, and a job development order table 113.

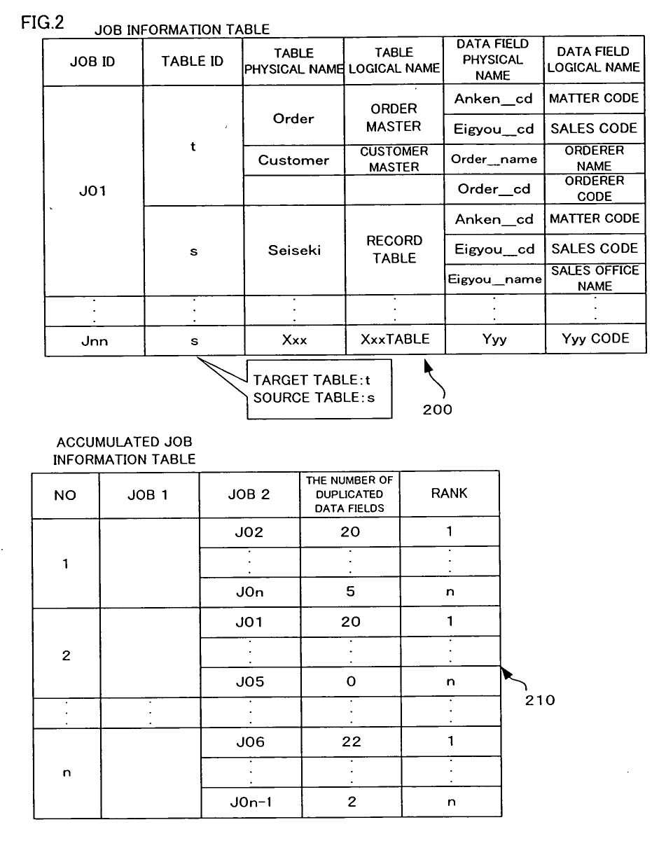

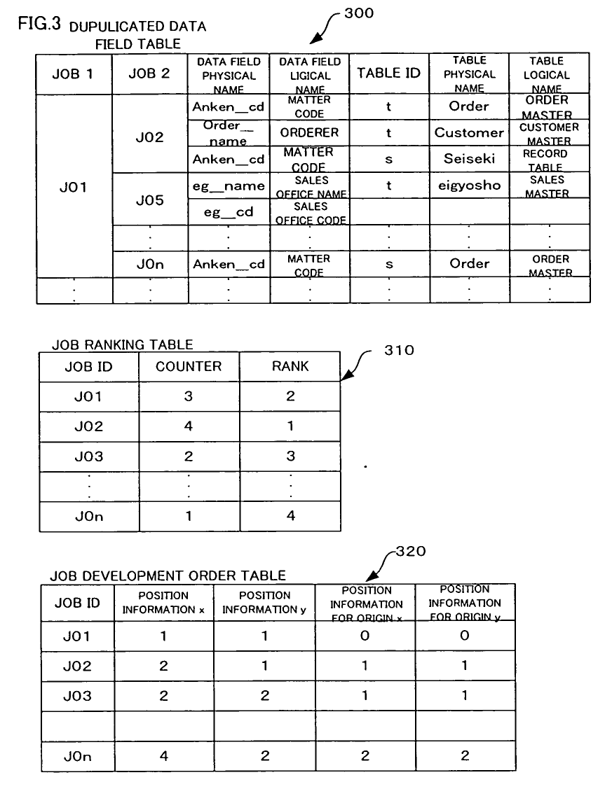

Subsequently, the data structures of the respective tables 103, 107, 108, 112, and 113 will be described. FIG. 2 is a view showing Table Group 1 in the present embodiment, and FIG. 3 is a view showing Table Group 2 in the present embodiment.

As shown in the data structure 200 of FIG. 2, using as a key the job ID of each job of the ETL process, the job information table 103 relates data for each of a data extraction source (in FIG. 2, “s” which means a source; there is a notation of “table ID”) and a data storing destination (in FIG. 2, “t” which means a target (destination); there is a notation of “table ID”) in the job. Here, the related data contains table attributes, such as table physical names and table logical names, and data field attributes, such as data field physical names and data field logical names, in addition to the table IDs.

The duplicated data field table 107 is a list of the jobs which have table attributes and data field attributes matching between the respective jobs of the ETL process for each of the data extraction source and the data storing destination. As shown in FIG. 3, in the data structure 300, each job (Job 1 in FIG. 3) is related with “other jobs” (Job 2 in FIG. 3) which have table attributes and data field attributes matching the table attributes and data field attributes of the job, and the data field names (physical names and logical names), table IDs, table physical names, and table logical names of the “other jobs.”

The accumulated job information table 108 is a list of the jobs which have table attributes and data field attributes matching between the respective jobs of the ETL process for each of the data extraction source and the data storing destination. In this table, each job is related with the numbers (matching degrees) of duplicated data fields among the data field attributes of “other jobs”. As shown in FIG. 2, in the data structure 210, each job (in FIG. 2, Job 1: J01 to J0n) is related with “other jobs” (Job 2 in FIG. 2) which have table attributes and data field attributes matching the table attributes and data field attributes of the job, the numbers of duplicated data fields, and the ranks according to the numbers of the duplicated data fields.

The job ranking table 112 is a table obtained by counting the frequency in which the matching degree is identified to be highest in the respective jobs, for each of the “other jobs” having the highest matching degree (the number of duplicated data fields) in the accumulated job information table 108, and by ranking the “other jobs.” The data structure 310 relates the job IDs of the “other jobs” as keys with the frequencies (“counter” in FIG. 3) and rank data according to the amount of frequencies.

The job development order table 113 shows the “other jobs” constituting the job ranking table 112, with coordinate information for displaying a tree view on the output interface. Therefore, in the data structure 320, the job IDs of the “other jobs” as keys are related with position information x (x coordinates) and position information y (y coordinates) on the xy coordinates of the output interface, and position information x for origin and position information y for origin representing the roots to which the “other jobs” are to be connect to.

Incidentally, the tables constituting the table groups, i.e., the job information table 103, the duplicated data field table 107, the accumulated job information table 108, the job ranking table 112, and the job development order table 113, may operate integrally with the system 100 via a network while being attached to an other device, other than the example in which the tables are integrally built in the system 100.

Moreover, for the respective networks for coupling between the system 100, the ETL tool system 50, the transaction system 10, and the data warehouse 40, various networks including a private line, a wide area network (WAN), Powerline Internet, a wireless network, a public phone network, a cellular phone network, an electronic data interchange (EDI) private network, and the like can be employed, other than a LAN and the Internet. Further, the use of virtual private network technology, such as VPN, establishes communications with increased security when the Internet is employed, thus being suitable.

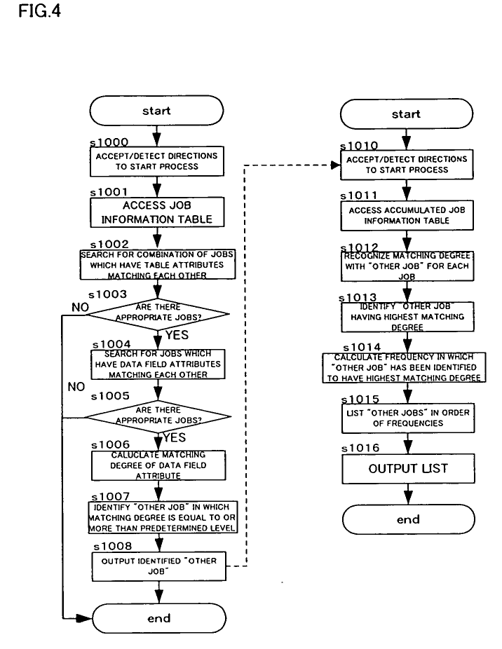

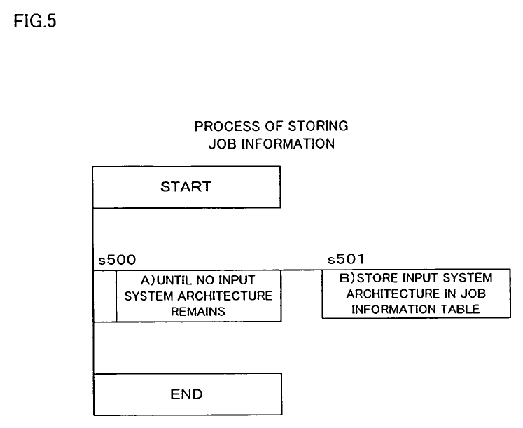

FIG. 4 is a main flow diagram of the job management method of the present embodiment. Moreover, detailed flows will be shown in FIG. 5 and the following figures. Hereinafter, the actual procedure of the job management method of the present invention will be described in line with the various flow diagrams. Note that various operations corresponding to the job management method, which will be described below, are realized by programs built in the system 100. These programs include codes for performing various operations described below.

First, the main flow will be described. For example, the system 100 is assumed to accept directions to start job management from the ETL tool system 50 (s1000). Alternatively, the system 100 detects that the preset time to start job management has come, using its own calendar function or the like. Note that the main process of the above-described job management is a process of selecting a reusable job from the jobs of the architectured ETL process.

The system 100 which starts job management accesses the job information table 103 (s1001). As shown in FIG. 5, information (input system architecture in FIG. 5) of jobs existing in the ETL tool system 50 is previously stored in the job information table 103 by the system architecture input program 101 (s500, s501).

The system 100 searches the jobs stored in the job information table 103 for combinations of the jobs which have table attributes matching each other (s1002). At this time, if there are no appropriate jobs, the process is terminated (s1003: NO). On the other hand, if there are appropriate jobs (s1003: YES), the system 100 searches these jobs for combinations of the jobs which have data field attributes matching each other (s1004). At this time, if there are no appropriate jobs, the process is terminated (s1005: NO).

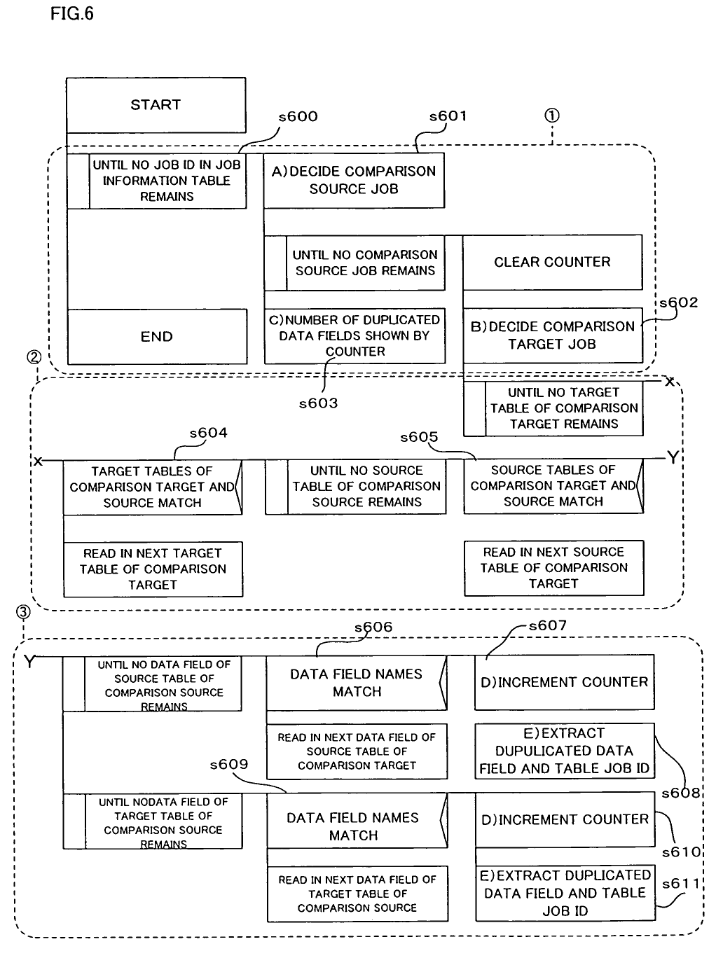

Incidentally, as shown in FIG. 6, the above-described search process is performed on all job IDS in the job information table 103 (s600). In each combination of the jobs, for example, the job having a smaller job ID is used as a base point and simply set as a “job” (comparison source job) (s601), and the job which is checked for the matching degree with the “job” is set as “other job” (comparison target job) (s602). Thus, the system 100 searches for “other jobs” which are checked for the matching of the target tables and the source tables (s604, s605). Then, the “other jobs” retrieved here are checked for the matching of the data field attributes (s606 to s611).

On the other hand, if there are appropriate jobs in Step s1005 (s1005: YES), then, for each of these jobs, the system 100 calculates the matching degrees of the data field attributes of the “other jobs,” which have matched each other (s1006). As the matching degree, the number of data fields which have matched each other can be assumed (also in FIG. 6, the number of data fields matching each other is counted in Steps s603, s607, and s610).

Note that information of the jobs which have been retrieved until Step s1005 and have table attributes and data field attributes matching each other is stored in the duplicated data field table 107. Moreover, the matching degrees are stored in the accumulated job information table 108.

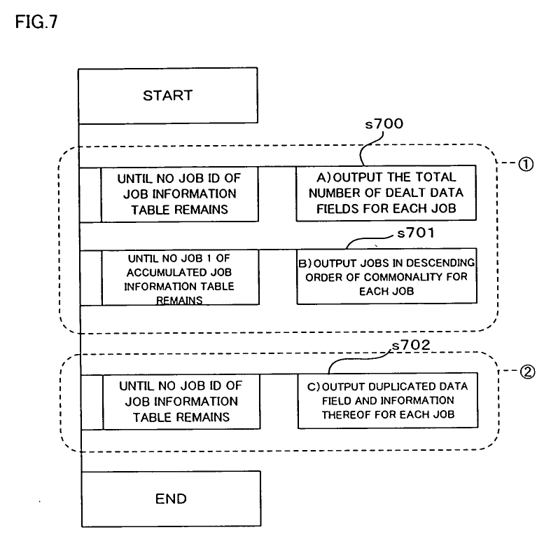

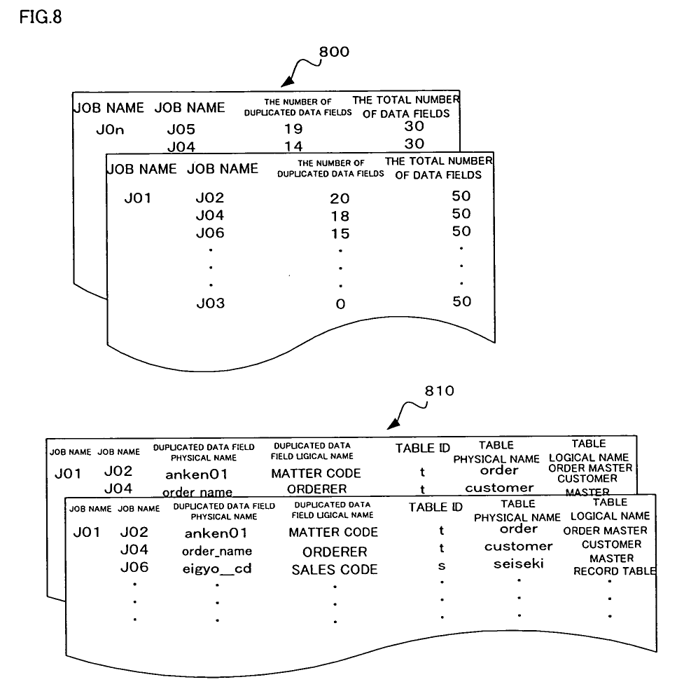

Subsequently, the system 100 identifies the “other jobs” in which the calculated matching degrees are equal to or more than a predetermined level (s1007). The identified “other jobs” are outputted to the output interface (s1008), and the process is terminated. As shown in FIG. 7, in the above-described output process, the corresponding “other jobs” and the numbers of duplicated data fields (matching degrees) are extracted from the accumulated job information table 108 for each “job,” and the “other jobs” are listed in the state where the “other job” having a larger number of duplicated data fields ranks higher (s700, s701). An output form example for this is an output example 800 shown in FIG. 8.

Moreover, details of duplicated data fields are outputted as shown in an output example 810 by extracting duplicated data fields and the contents thereof for each “job” from the duplicated data field table 107 (s702). This output contains data such as the physical names and logical names of duplicated data fields in the relationships between the “job” and the “other jobs” retrieved as similar jobs to the “job.” The process so far is executed by the job comparison program 104.

The flow may be terminated after the output process described above. Alternatively, the ordering of job development may be performed by using the accumulated job information table 108 generated until Step s1008.

In this case, the system 100 accesses the accumulated job information table 108 (s1010, s1011) and recognizes the matching degrees with the “other jobs” for each job (s1012). Then, for each job, the system 100 identifies the “other job” which has the highest matching degree, that is, which has the largest number of duplicated data fields and is ranked first (s1013). Moreover, if the “other job” identified here is also identified to have the highest matching degree for other of “jobs,” the frequencies are counted up (s1014). The “other job” which has the highest frequency, i.e., which is most frequently ranked first, is set as a job of origin.

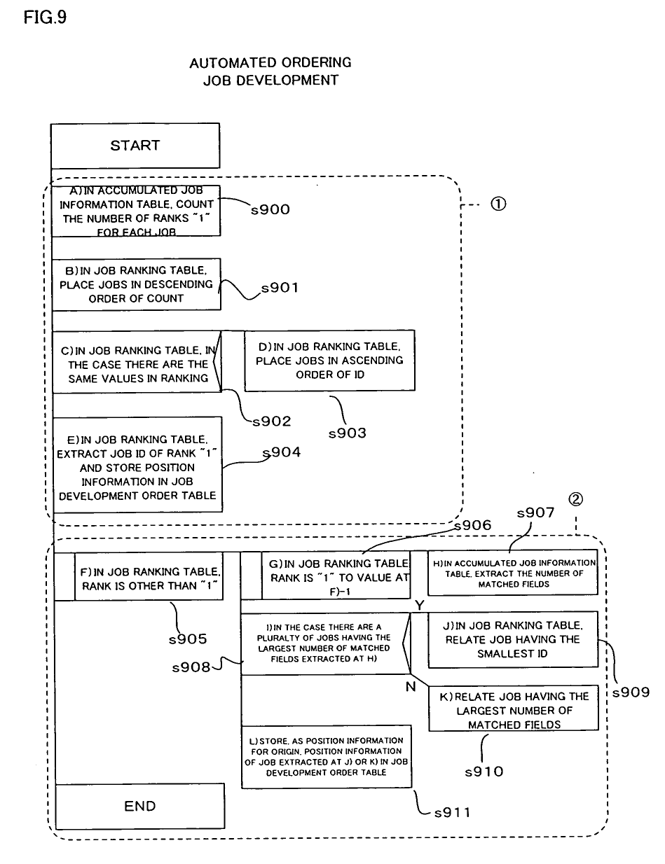

Details of such a process flow is shown in FIG. 9. For example, the number of times when each job is ranked first is counted for each job based on the accumulated job information table 108 (s900), and then these are listed as the job ranking table 112 (s901). If there are same counters in the present rank list (s902: YES), for example, the jobs are placed in ascending order of job IDs (s903). On the other hand, if there are no same counters (s902: NO), the job which is ranked first in the job ranking table 112 is set as the job of origin and stored in the job development order table 113 (s904).

If the “other jobs” are listed in order of the frequencies in which the “other jobs” are ranked first, as described above (s1015), then the ordering of job development is performed by using the job of origin as an origin. As the flow of the process, the numbers of duplicated data fields are extracted from the accumulated job information table 108 for the “other jobs” except for the job of origin (s905, s906, s907). If there are a plurality of “other jobs” which have the same numbers of duplicated data fields among the “other jobs” having the largest numbers of duplicated data fields extracted here (s908: YES), the “other job” having the smallest job ID is related with the job of origin (s909). On the other hand, if there are no “other jobs” having the same field numbers (s908: NO), the “other job” having the largest number of duplicate fields is related with the job of origin (s910).

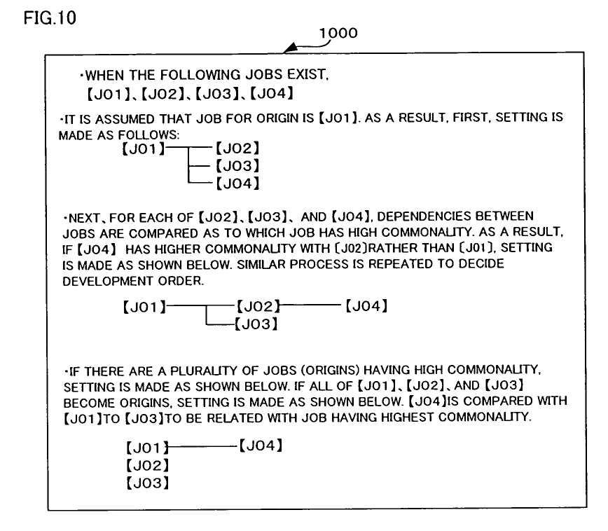

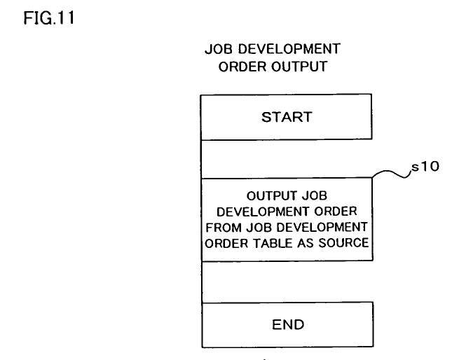

Such “other job” having the largest number of duplicated data fields is sequentially selected after the job of origin to be stored in the job development order table 113 (s911, s10 in FIG. 11). Note that the concept shown in FIG. 10 can be employed as a concept for relating the “other jobs” after the job of origin. In this concept, the job “J01” of origin is set as a root, and the jobs “J02 to J04” which are similar to “J01” and which can reuse “J01” are related as the next layer.

Subsequently, dependencies between these jobs “J02 to J04” are examined, and the job “J02” having the highest dependency on “J01” is selected first. The dependency can be examined by comparing the numbers of duplicated data fields between the jobs. A tree structure using the job “J01” of origin as a root can be formed by performing similar processes also for jobs to be connected to layers below the job “J02.” Note that, if there are a plurality of jobs having the same high degree of dependency, a tree structure is formed by using the plurality of jobs as jobs of origin.

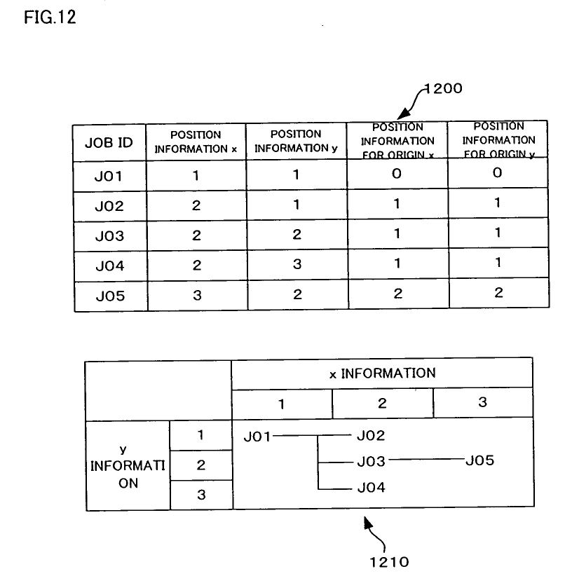

The tree structure thus formed includes coordinate values on the output interface as shown in a data structure example 1200 of FIG. 12. The output thereof is performed in the form shown in an output example 1210 of the tree structure. The system 100 outputs the tree structure (list) to the output interface in this way (s1016), and the process is terminated.

According to the job management method and the like of the present invention, jobs in an ETL process can be reused.

Although the preferred embodiment of the present invention has been described in detail, it should be understood that various changes, substitutions and alterations can be made therein without departing from spirit and scope of the inventions as defined by the appended claims.

According to the present invention, jobs in an ETL process can be reused.

What is claimed is:

1. A method for managing jobs of an ETL process using an information processing device, the method comprising the steps of:
accessing a job information table in the information processing device which records contents of the respective jobs of the ETL process;
retrieving the jobs which have contents partially or exactly matching between the respective jobs; and
outputting, for each retrieved job, an other job in which the matching has been confirmed to an output interface.

2. A job management method according to claim 1,
wherein in recording of the contents of the respective jobs in the job information table, for each job, a table attribute and a data field attribute related with each of a data extraction source and a data storing destination, which are the contents of the job, are recorded and
other jobs retrieved in the retrieving step are jobs which have table attributes and data field attributes matching between the respective jobs.

3. A job management method according to claim 2, further comprising the step of:
calculating, for each retrieved job, a matching degree of the other jobs in which the matching has been confirmed,
wherein in the outputting step, the other jobs are outputted based on the calculated matching degree.

4. A job management method according to claim 3, comprising the step of:
identifying the other job in which the calculated matching degree is equal to or more than a predetermined level, the calculated matching degree of the other job being a matching degree of the data field attributes of the other job in which the matching has been confirmed,
wherein in the outputting step, the identified other job is outputted.

5. A method for managing jobs of an ETL process using an information processing device, the method comprising the steps of:
accessing a matching information table in the information processing device in which the jobs having table attributes and data field attributes matching between the respective jobs of the ETL process for each of a data extraction source and a data storing destination are listed and in which each job is related with a matching degree of the data field attribute with an other job, recognizing the matching degree with the other job for each job, and identifying the other job having the highest matching degree for each job; and
outputting the identified other job.

6. A method according to claim 5, further comprising the step of:
calculating frequencies in which the identified other jobs have been identified to have the highest matching degrees for the respective jobs,
wherein in the outputting step, the identified other jobs are listed in order of the calculated frequencies and outputted.

7. A method according to claim 6,
wherein the matching degree is the number of duplicated data fields of the data field attribute, and
wherein in the outputting step, the other jobs are outputted in a state where the other job having the highest calculated frequency and the identified other job are related in accordance with the number of duplicated data fields between the other job having the highest frequency and the identified other job.

8. A job management program for causing an information processing device to execute a method for managing jobs of an ETL process, the job management program comprising the codes for executing the steps of:
accessing a job information table which records contents of the respective jobs of the ETL process, and retrieving a job which have contents partially or exactly matching between the respective jobs;
calculating, for each retrieved job, a matching degree of an other job in which the matching has been confirmed; and
outputting the other job based on the calculated matching degree for each retrieved job.

9. A job management program according to claim 8,
wherein in the contents of the respective jobs, table attributes and data field attributes are related with each of a data extraction source and a data storing destination of each job, and
wherein in the retrieving step, the jobs which have the table attributes and the data field attributes matching between the respective jobs are retrieved.

10. A job management program according to claim 8,
wherein the information table records table attributes and data field attributes in a state where, for each job, the table attributes and the data field attributes are related with each of a data extraction source and a data storing destination, which are contents of the job,
the other jobs retrieved in the retrieving step are jobs which have the data attributes and the data field attributes matching between the respective jobs, and
the matching degree of the other job is a matching degree of the data field attribute of the other job.

11. A job management program according to claim 10, further comprising the step of:
identifying the other job in which the calculated matching degree of the data field attribute of the other job is equal to or more than a predetermined level,
wherein in the outputting step, the identified other job is outputted.

12. A job management program according to claim 8,
wherein the matching degree of the other job is the number of duplicated data fields of the data field attribute between the retrieved job and the other job, and
wherein in the outputting step, for each retrieved job, the other job in which the matching has been confirmed and the number of duplicated data fields are outputted in a state where the other job and the number of duplicated data fields are related.

13. A job management program for causing an information processing device to execute a method for managing jobs of an ETL process, the job management program comprising the codes for executing the steps of:
accessing a matching information table which records other jobs having contents partially or exactly matching between the respective jobs of the ETL process and matching degrees of the other jobs for each job, recognizing the matching degrees of the other jobs for each job, and identifying the other job having the highest matching degree for each job; and
outputting the identified other jobs.

14. A job management program according to claim 13, further comprising the codes for executing the step of:
calculating frequencies in which the identified other jobs are identified to have the highest matching degrees for the respective jobs,
wherein in the outputting step, the identified other jobs are listed in order of the frequencies and outputted.

15. A job management program according to claim 14,
wherein the other jobs having contents partially or exactly matching between the respective jobs are other jobs having table attributes and data field attributes matching between the respective jobs for each of a data extraction source and a data storing destination, and
the matching degrees are matching degrees of the data field attributes of the other jobs for each job.

16. A computer-readable recording medium having a job management program recorded thereon, the job management program causing an information processing device to execute a method for managing jobs of an ETL process, the information processing device being capable of accessing a job information table in which a table attribute and a data field attribute are related with each of a data extraction source and a data storing destination in each job of the ETL process, the job management program comprising the codes for executing the steps of:
accessing the job information table, and retrieving the jobs which have the table attributes and the data field attributes matching between the respective jobs;
calculating, for each retrieved job, a matching degree of the data field attribute of an other job in which the matching has been confirmed;
identifying the other job which has the calculated matching degree equal to or more than a predetermined level; and
outputting the identified other job to an output interface.

17. A computer-readable recording medium according to claim 16,
the information processing device being capable of accessing a matching information table in which the jobs having the table attributes and the data field attributes matching between the respective jobs of the ETL process for each of the data extraction source and the data storing destination are listed and in which each job is related with the matching degree of the data field attribute with the other job, the job management program comprising the codes for executing the steps of:
accessing the matching information table, recognizing the matching degree with the other job for each job, and identifying the other job having the highest matching degree for each job;
calculating frequencies in which the identified other jobs have been identified to have the highest matching degrees for the respective jobs; and
listing the other jobs in order of the frequencies, and outputting the other jobs to the output interface.

18. An information processing device for managing jobs of an ETL process, the information processing device comprising:
a job information table recording a table attribute and a data field attribute in a state where, for each job, the table attribute and the data field attribute are related with each of a data extraction source and a data storing destination, which are contents of the job;
a unit for accessing the job information table and retrieving jobs which have the table attributes and the data field attributes matching between the respective jobs;
a unit for calculating, for each retrieved job, a matching degree of an other job in which the matching has been confirmed; and
a unit for outputting the other job in which the matching has been confirmed, to an output interface for each retrieved job based on the calculated matching degree.

19. An information processing device according to claim 18, further comprising:
a unit for identifying the other job in which the calculated matching degree of the data field attribute of the other job is equal to or more than a predetermined level,
wherein the unit for outputting the other job outputs the identified other job.

20. An information processing device according to claim 18, further comprising:
a unit for storing the matching degree of the data field attribute with the other job in a matching information table for each retrieved job in a state where the matching degree of the data field attribute with the other job is related with the retrieved job;
a unit for accessing the matching information table, recognizing the matching degree with the other job for each job, and identifying the other job having the highest matching degree for each job;
a unit for calculating frequencies in which the identified other jobs have been identified to have the highest matching degrees for the respective jobs; and
a unit for listing the identified other jobs in order of the frequencies and outputting the identified other jobs.
